(19) United States
(12) Patent Application Publication
(10) Pub. No.: US 2017/0109702 A1
(43) Pub. Date: Apr. 20, 2017

(54) CAMPUS HIRING WORKFLOW

(71) Applicant: LinkedIn Corporation, Mountain View, CA (US)

(72) Inventors: Arjun Naren Ramnath, Bangalore (IN); Deepak Chaturbhuj Pakhare, Bengaluru (IN); Ganesan Venkatasubramanian, Bangalore (IN); Nitant Nikhilkumar Vaidya, Bangalore (IN)

(21) Appl. No.: 15/285,119

(22) Filed: Oct. 4, 2016

(30) Foreign Application Priority Data
Oct. 16, 2015 (IN) 5563/CHE/2015

(51) Int. Cl. G06Q 10/10

(52) U.S. Cl. CPC G06Q 10/1053; G06Q 10/1095; G06Q 50/20

(57) ABSTRACT

Disclosed in some examples, are methods, systems, and machine readable mediums, which provide one, or more graphical user interfaces, which provide for a semi-automated campus hiring flow for a plurality of companies, educational institutions, and job seekers. When seeking employment, students work with placement officers who invite companies to participate in campus hiring. Recruiters with these companies arrange visits with the placement officers, and the placement officers approve the job postings and visit dates. The placement officers send a list of approved students for specific positions to the recruiter, and the recruiter selects students of interest and invites those students to take tests or to conduct interviews. The recruiter makes job offers to specific students through the placement officer, the placement officer then forwards the offers to students, and those students may accept or decline.

### CLAIM OF PRIORITY

This patent application claims the benefit of priority of Indian Provisional Patent Application Serial Number 5563/CHE/2015, titled “Campus Hiring Workflow,” filed on Oct. 16, 2015, which is hereby incorporated by reference herein in its entirety.

### FIELD OF INVENTION

Some embodiments pertain to automated workflows for campus hiring. Some embodiments relate to automated workflows for campus hiring using a social networking service.

### BACKGROUND

Many colleges and other educational institutions provide career counseling and job placement. Often, job placement includes placing students in contact with company representatives, such as through on-campus interviews. However, on-campus hiring traditionally has been a complicated and manual process, a process that has relied on many different spreadsheets, documents, and disparate communications managed by various campus representatives and student volunteers. What is needed is an improved process for campus hiring.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram showing the components of a social networking service in accordance with some embodiments.

FIG. 2 illustrates an example campus hiring platform in accordance with some embodiments.

FIG. 3 illustrates a placement officer user interface in accordance with some embodiments.

FIG. 4 illustrates a flowchart showing a technique for monitoring placement activity in accordance with some embodiments.

FIG. 5 illustrates an example recruiter user interface for posting jobs in accordance with some embodiments.

FIG. 6 illustrates an example recruiter user interface for selecting candidates in accordance with some embodiments.

FIG. 7 illustrates a flowchart showing a technique for selecting candidates for a job in accordance with some embodiments.

FIG. 8 illustrates an example student user interface in accordance with some embodiments.

FIG. 9 illustrates a flowchart showing a technique for applying for a job in accordance with some embodiments.

FIG. 10 shows a flowchart of a campus hiring method in accordance with some embodiments.

FIG. 11 illustrates generally an example of a block diagram of a machine upon which any one or more of the techniques (e.g., methodologies) discussed herein may perform in accordance with some embodiments.

### DETAILED DESCRIPTION

When seeking employment, students may work with placement officers. These placement officers are often employed by a university or other educational institution. The placement officers may invite companies to campus. Recruiters with these companies arrange visits with the placement officers, and the placement officers approve the job postings and visit dates. Placement officers then may work with student coordinators who solicit interest from students. The student coordinators track which of their friends and acquaintances are interested and send these lists back to the placement officers. The placement officers aggregate the lists from the student coordinators and then approve or deny the students. The approved students then send the approved list to the recruiter from the company. The recruiter then selects students of interest and invite those students to take tests or to conduct interviews. After the tests and interviews, the recruiter makes job offers to specific students through the placement officer. The placement officer then forwards the offers to students, and those students may accept or decline. This process relies upon ad-hoc communications, e-mails, and spreadsheets maintained by the placement officers, recruiters, student coordinators, and other individuals. Disclosed in some examples, are methods, systems, and machine readable mediums, which provide one or more graphical user interfaces that provide for a semi-automated campus hiring flow for a plurality of companies, educational institutions, and job seekers.

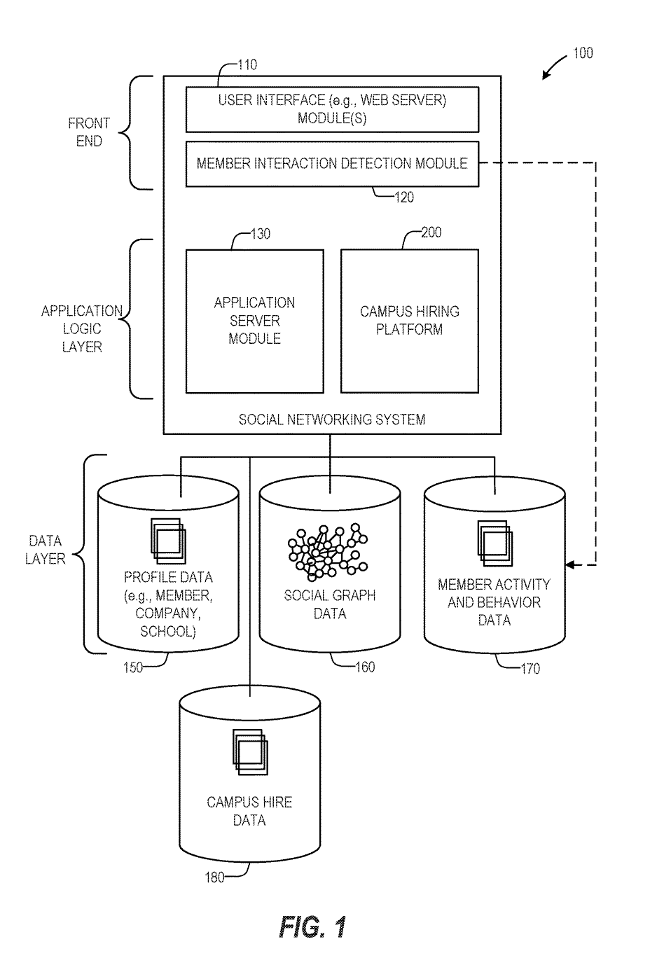

FIG. 1 is a block diagram showing the components of a social networking service 100, in accordance with some embodiments. As shown in FIG. 1, a front end may comprise a user interface module (e.g., a web server) 110, which receives requests from various client-computing devices, and communicates appropriate responses to the requesting client devices. For example, the user interface module(s) 110 may receive requests in the form of Hypertext Transport Protocol (HTTP) requests, or other network-based, application programming interface (API) requests (e.g., from a dedicated social networking service application running on a client device). In addition, a member interaction and detection module 120 may be provided to detect various interactions that members have with different applications, services, and content presented. As shown in FIG. 1, upon detecting a particular interaction, the member interaction, and detection module 120 logs the interaction, including the type of interaction and any meta-data relating to the interaction, in the member activity and behavior database 170.

An application logic layer may include one or more various application server modules 130, which, in conjunction with the user interface module(s) 110, generate various graphical user interfaces (e.g., web pages) with data retrieved from various data sources in the data layer. With some embodiments, application server module 130 is used to implement the functionality associated with various applications and/or services provided by the social networking service as discussed above.

Application layer may also include campus hiring platform module 200, which may provide graphical user interfaces to implement the campus hiring platform as described herein. Campus hiring platform module 200 may provide one or more graphical user interfaces to allow placement officers to sign up and setup their college, add and invite students, invite recruiters, approve jobs posted by recruiters, approve student lists to send to recruiters for open jobs, monitor placement activity and control offer announcements to students. Campus hiring platform module 200 may provide one or more graphical user interfaces to allow recruiters to sign up and setup their organization, post jobs, view students interest in jobs and select students for interviews or testing, and make offers. Campus hiring platform module 200 may provide one or more graphical user interfaces to allow students to sign up, browse jobs, and express interest in jobs, complete assessments, provide reminders for interviews, and accept or reject offers. Campus hiring platform module 200 may provide one or more graphical user interfaces to allow student coordinators to view placement activity and coordinate interviews. Placement officers, student coordinators, recruiters, and students may sign up and create an account on the social networking service, and be added to the campus hiring platform. The accounts of these individuals are linked to the campus hiring platform 200.

The social networking service 100 may include a data layer that may include several other databases, such as a database 150 for storing profile data, including both member profile attributes as well as profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 150. Similarly, when a representative of an organization initially registers the organization with the social networking service, the representative may be prompted to provide certain information about the organization. This information may be stored, for example, in the database 150, or another database (not shown). With some embodiments, the profile data may be processed (e.g., in the background or offline) to generate various derived profile data. For example, if a member has provided information about various job titles that the member has held with the same company or different companies and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Information describing the various associations and relationships, such as connections that the members establish with other members or with other entities and objects are stored and maintained within a social graph in the social graph database 160. Also, as members interact with the various applications, services and content made available via the social networking service, the members' interactions and behavior (e.g., content viewed, links or buttons selected, messages responded to, etc.) may be tracked and information concerning the member's activities and behavior may be logged or stored, for example, as indicated in FIG. 1 by the member activity and behavior database 170. Campus hire data 180 may store information about schools, jobs, organizations, recruiters, placement officers, students, student coordinators, and other information to enable the functionality of the campus hiring platform 200. Campus hire data 180 may also store associations between recruiters, jobs, schools, students, placement officers, student coordinators, and other campus hiring platform participants to enable campus hiring platform 200 to provide the necessary process flows.

With some embodiments, the social networking system 100 provides an application programming interface (API) module with the user interface module 110 via which applications and services can access various data and services provided or maintained by the social networking service. For example, using an API, an application may be able to request or receive one or more navigation recommendations. Such applications may be browser-based applications, or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the navigation recommendations available to third party applications and services.

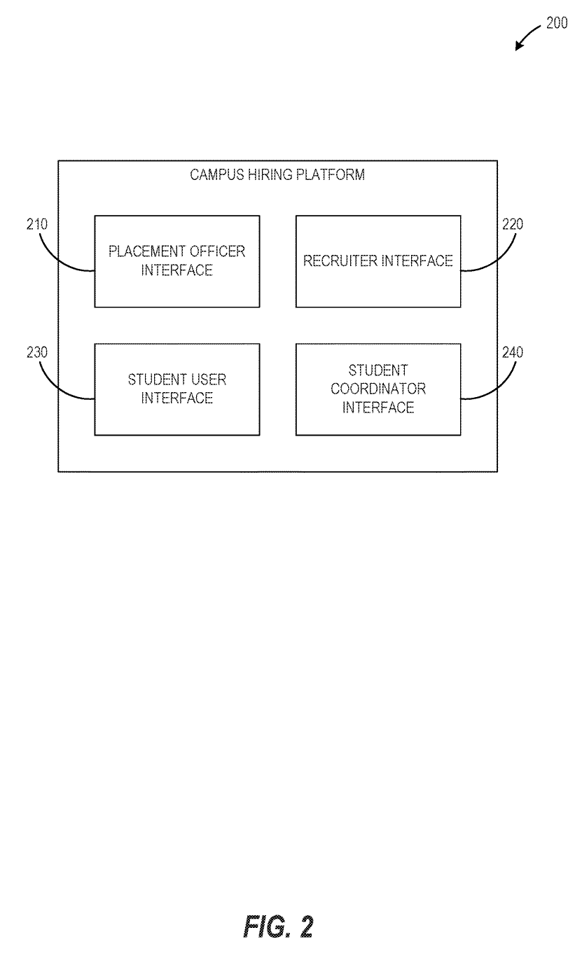

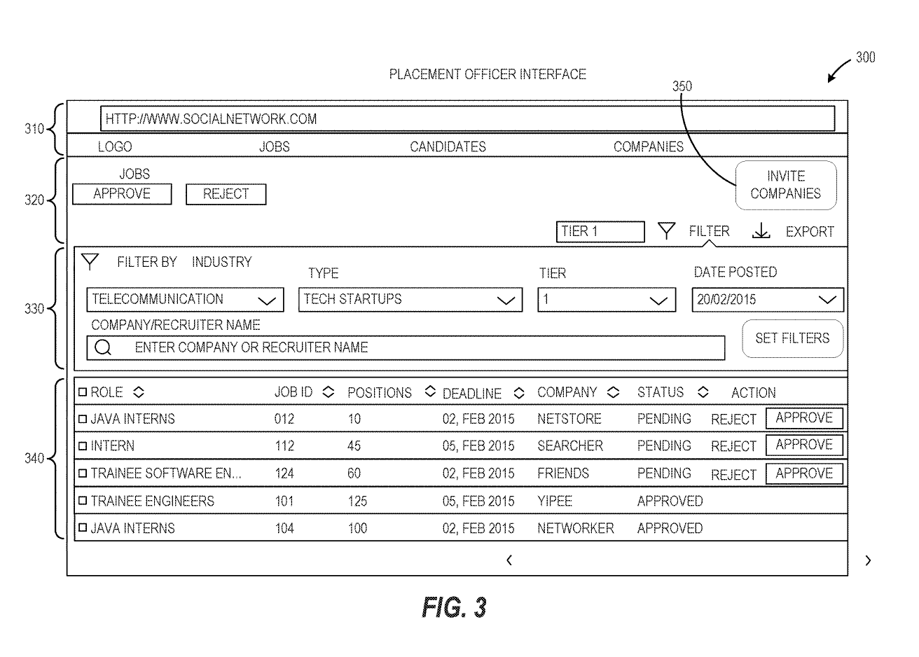

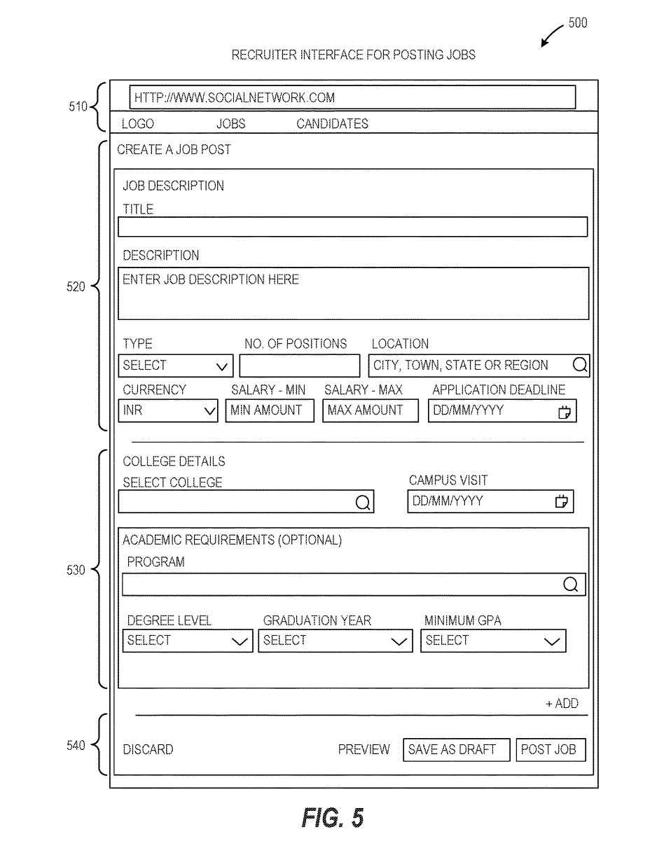

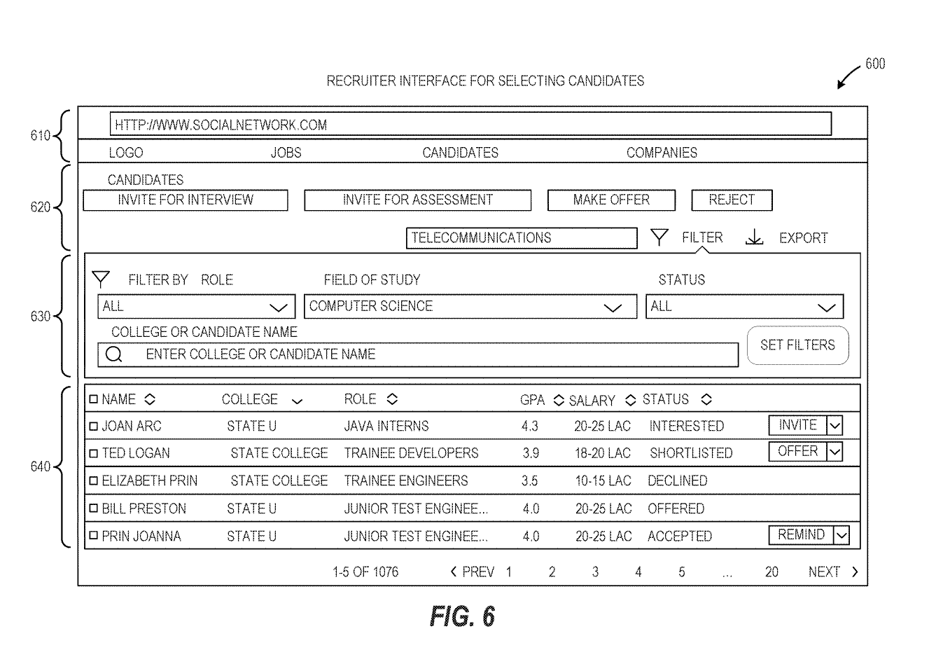

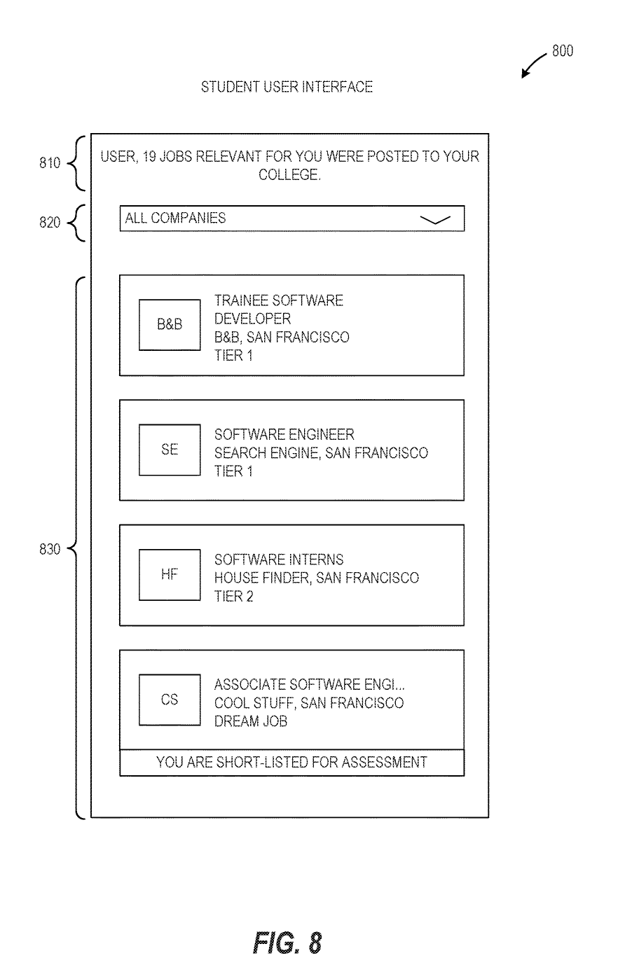

FIG. 2 illustrates an example campus hiring platform 200 in accordance with some embodiments. Platform 200 includes a placement officer user interface 210, a recruiter user interface 220, a student user interface 230, and a student coordinator user interface 240. The placement officer interface 210 provides one or more graphical user interfaces for placement officers to sign up and setup their college, add and invite students, invite recruiters, approve jobs posted by recruiters, approve student lists to send to recruiters for open jobs, monitor placement activity and control oiler announcements to students. An example placement officer user interface 210 is shown in FIG. 3. Recruiter interface module 220 may provide one or more graphical user interfaces for recruiters to sign up and setup their organization, post jobs, view students interest in jobs and select students for interviews or testing, and make offers. Examples recruiter user interfaces 220 are shown in FIGS. 5-6. Student interface module 230 may provide one or more graphical user interfaces to allow students to sign up, browse jobs, express interest in jobs, complete assessments, provide reminders for interviews, and accept or reject offers. An example student user interface 230 is shown in FIG. 8. Coordinator interface 240 may provide one or more graphical user interfaces to allow student coordinators to view placement activity and coordinate interviews.

FIG. 3 illustrates a placement officer interface 300 in accordance with some embodiments. Interface 300 may include a navigation area 310, which may include an address bar and one or more navigation buttons. Interface 300 may include a job disposition area 320, which may include one or more buttons to approve or reject jobs based on their descriptions. Interface 300 may include a filter area 330, which may be used to apply one or more filters to a list of available job positions. Interface 300 may include a list of available job positions 340. List 340 includes a check box next to each job position to enable selecting and taking action on one or more positions, such as approving or rejecting a job using the buttons within job disposition area 320. List 340 also includes various fields to allow for sorting jobs by role, job ID, number of available positions, application deadline, hiring company, job status, and available job actions. The available job actions may allow a placement officer to reject or approve each job, Interface 300 may include a button to invite additional companies to post job positions.

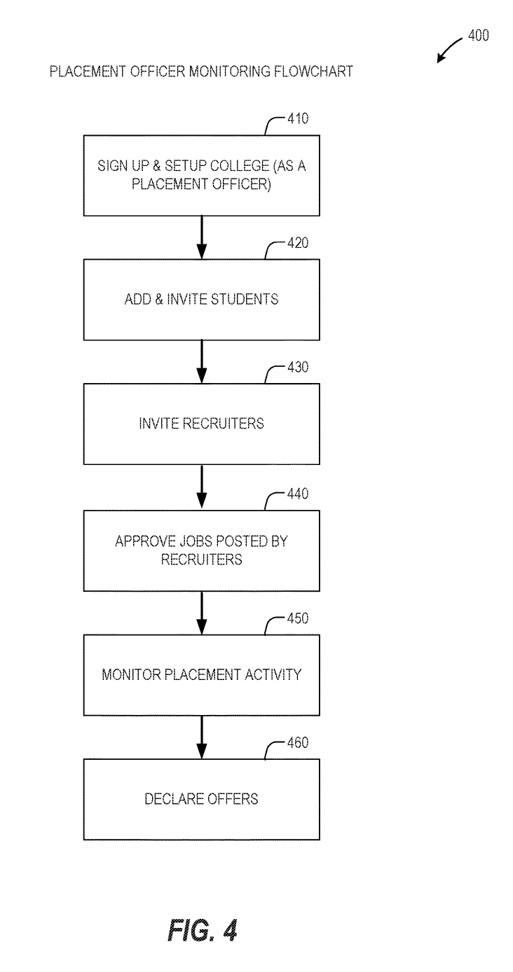

FIG. 4 illustrates a flowchart showing a technique for monitoring placement activity 400 in accordance with some embodiments. Monitoring placement activity 400 may be performed by a placement officer. Activity 400 includes signing up and setting up a college 410, which may include entering information relevant to campus hiring. For example, campus hiring information may include a total number of students, a list of student majors, a number of students in each major, a number of students looking for a part-time position or a full-time position, or other campus hiring information. Activity 400 includes adding and inviting students 420, which may include adding a student major, an expected graduation date, a description of student skills, or other student information. Activity 400 includes inviting recruiters 430, which may include adding contact information for each recruiter. Activity 400 includes approving jobs posted by recruiters 440. Approval 440 may include the placement officer reviewing and approving or rejecting available positions provided by recruiters. For example, a position may be rejected if it does not include all needed information. Activity 400 includes monitoring placement activity 450, which may include monitoring how long a position has been unfilled or how long a student has been looking for a position. Activity 400 includes declaring offers 460, which may include notifying a job candidate and marking the position as no longer available.

FIG. 5 illustrates an example recruiter user interface for posting jobs 500 in accordance with some embodiments. Recruiter interface 500 may include a navigation area 510, which may include an address bar and one or more navigation buttons. Recruiter interface 500 may include a job creation area 520, which may include prompts for entering a job title or a job description. Job creation area 510 may also include one or more drop-down menus or other GUI inputs, such as to enter a job type, number of positions, job address, salary, or application deadline. Recruiter interface 500 may include a college detail area 530, which may include prompts to enter a college, a campus visit date, and academic requirements. The academic requirements may be optional, and may include a program (e.g., a major), a degree level, a graduation year, or a minimum GPA. Recruiter interface 500 may include a job posting action area 540, which provides one or more buttons to discard. the job information, preview the job information, save the job information as a draft, or post the job information.

FIG. 6 illustrates an example recruiter user interface for selecting candidates 600 in accordance with some embodiments. Recruiter interface 600 may include a navigation area 610, which may include an address bar and one or more navigation buttons. Recruiter interface 600 may include a candidate action area 620, which may allow the recruiter to invite the candidate for an interview, invite the candidate for an assessment, make an offer to the candidate, reject the candidate, or view candidate telecommunications (e.g., a history of e-mails relevant to the candidate job search). Recruiter interface 600 may include a candidate filter area 630, which may allow the recruiter to filter candidates by role, field of study, or filter by entering candidate search criteria. Recruiter interface 600 may include a list of student job candidates 640. List 640 includes a check box next to each candidate to enable selecting and taking action on one or more candidates, such as sending an invitation, sending an offer, or reminding the candidate of the position. List 340 also includes various fields to allow for sorting candidates by name, college, role, GPA, salary, and job position interest.

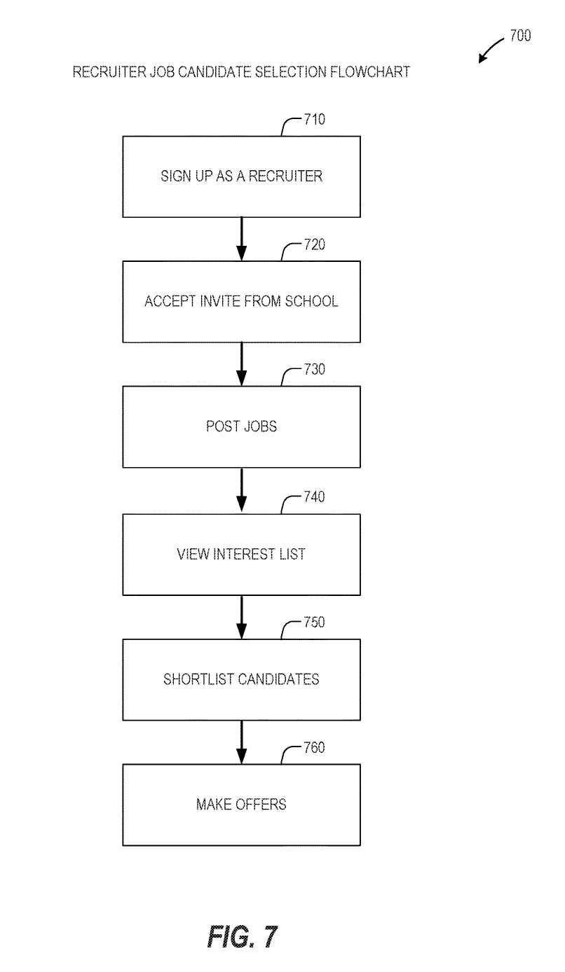

FIG. 7 illustrates a flowchart showing a recruiting technique for selecting candidates for a job 700 in accordance with some embodiments. Recruiting technique 700 includes signing up as a recruiter 710, which may include completing an online application for a recruiter position. A school may review and send offers to various recruiters, and recruiting technique 700 may include accepting a recruiter invitation from a particular school. The recruiter may then post one or more jobs 730, such as using the recruiter user interface for posting jobs shown in FIG. 5. The recruiter may then view a list of interested candidates 740, identify and shortlist specific candidates 750, and make offers 760, such as using the recruiter user interface for selecting candidates shown in FIG. 6.

FIG. 8 illustrates an example student user interface 800 in accordance with some embodiments. Student interface 800 may include a summary area 810, which may describe how many positions are relevant to the student. Interface 800 may include a filter 820 to select one or more companies or company categories. Interface 800 may include a position list area 830. Position list area 830 may include information about each position, such as the employer, position title, employer location, position tier information. The tier information may include an approximation of how well the position matches candidate preferences. For example, the tier information may indicate that the position is a Tier 1 match, a Tier 2 match, or a Dream Job match. Position list area 830 may also indicate positions for which the candidate has been short-listed.

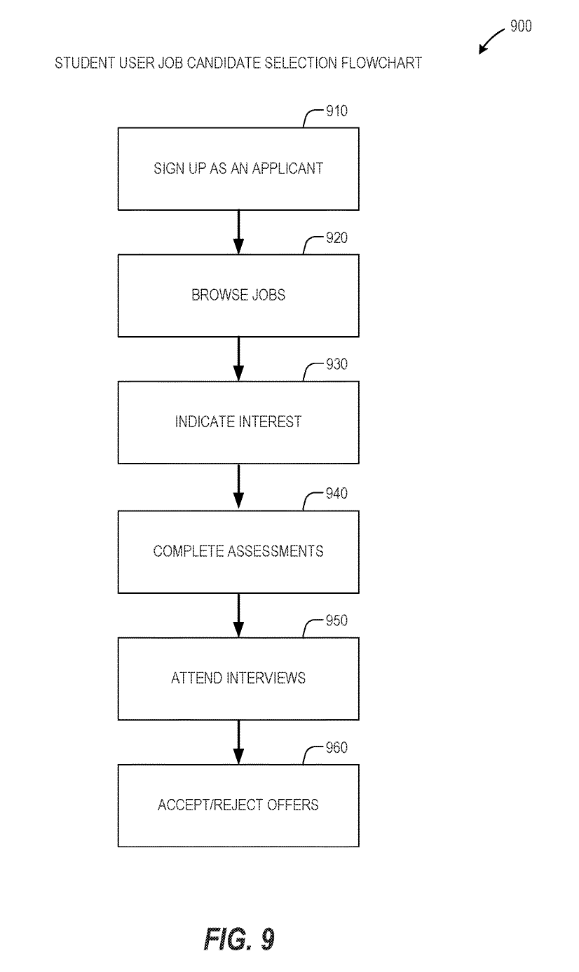

FIG. 9 illustrates a flowchart showing a technique for applying for a job 900 in accordance with some embodiments. Applying for a job 900 may include a student user signing up as an applicant 910, which may include uploading a resume or completing a resume template. The student may then browse available positions 920, such as shown in FIG. 8. The student may indicate an interest 930 in one or more positions. For each position in which the student indicates an interest, the student may be requested to complete one or more assessments 940. A student may then be invited to attend interviews 950. Finally, a student may accept or reject offers 960, where the offers may have been extended on behalf of an employer through a placement officer or recruiter.

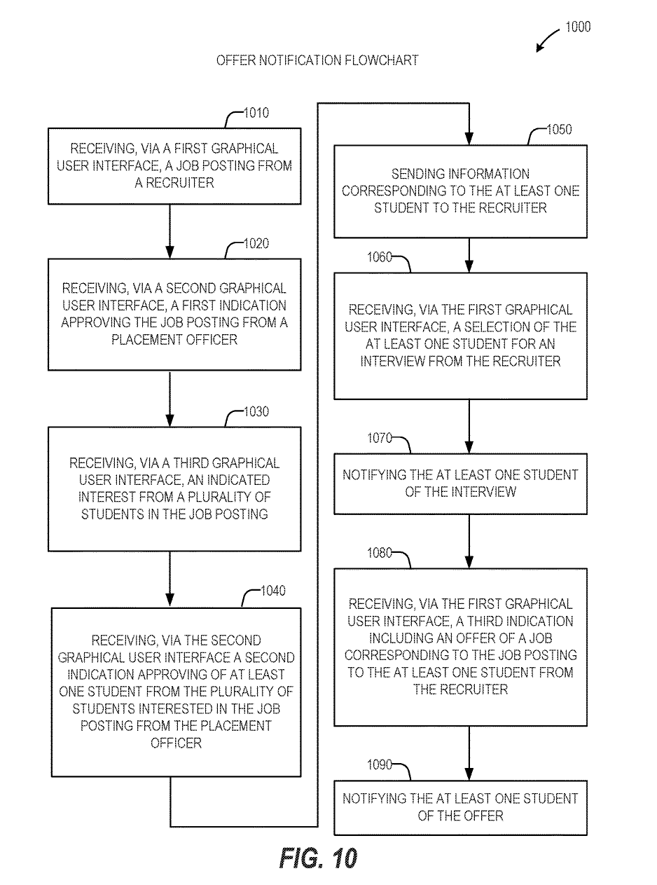

FIG. 10 shows a flowchart of a campus hiring method 1000 in accordance with some embodiments. Method 1000 may be executed by a campus hiring platform, such as a campus hiring server. A placement officer may invite a recruiter to use the campus hiring platform through the use of one of the previously described graphical user interfaces, such as by using an GUI button to invite companies. In response to the invitation, a recruiter may be registered through the use of other previously described graphical user interfaces provided by the campus hiring platform. The recruiter posts one or more jobs for one or more schools and enters one or more dates for a campus visit, and the campus hiring platform receives the job posting from the recruiter 1010. The placement officer, through a graphical user interface provided by the campus hiring platform, then approves or rejects the job posting and the campus visit dates for the schools that they manage, and the campus hiring platform receives the approval indication 1020. In some examples, the placement officer may propose modifications to the job listings or to the visit dates of the recruiter. Once the job posting is accepted, the campus hiring platform may provide a graphical user interface allowing registered students to register interest in the job posting, and the campus hiring platform receives the student interest indication 1030. The students were selected by the placement officer to participate in the campus hiring platform through another graphical user interface and were registered through yet another graphical user interface provided by the campus hiring platform.

The campus hiring platform may provide a graphical user interface allowing the placement officer to approve interested students, and the campus hiring platform receives the interest indication 1040. For example, some students that are interested may not be qualified or may have already accepted employment. The approved and interested students (also referred to as “candidates”) are sent to the recruiter, and the campus hiring platform receives the student information 1050.

The campus hiring platform may provide a graphical user interface (GUI) for recruiters to select the students they are interested in interviewing or testing, and the campus hiring platform receives the student identification 1060. The campus hiring platform the notifies the selected students 1070, where the notifications may be email, text message, or other communication. The campus hiring platform may provide a GUI for the recruiter to select which students will receive offers, and the campus hiring platform receives the job offer indication 1080. The campus hiring platform may notify the placement officer and provide a GUI for the placement officer to allow the placement officer to approve or reject offers. Students with approved offers are then notified 1080, and a GUI is provided allowing the students the opportunity to accept or reject the offer at operation 1090. The placement officer and the recruiter are notified of the student's decisions. The entire process is managed and tracked by the campus hiring platform.

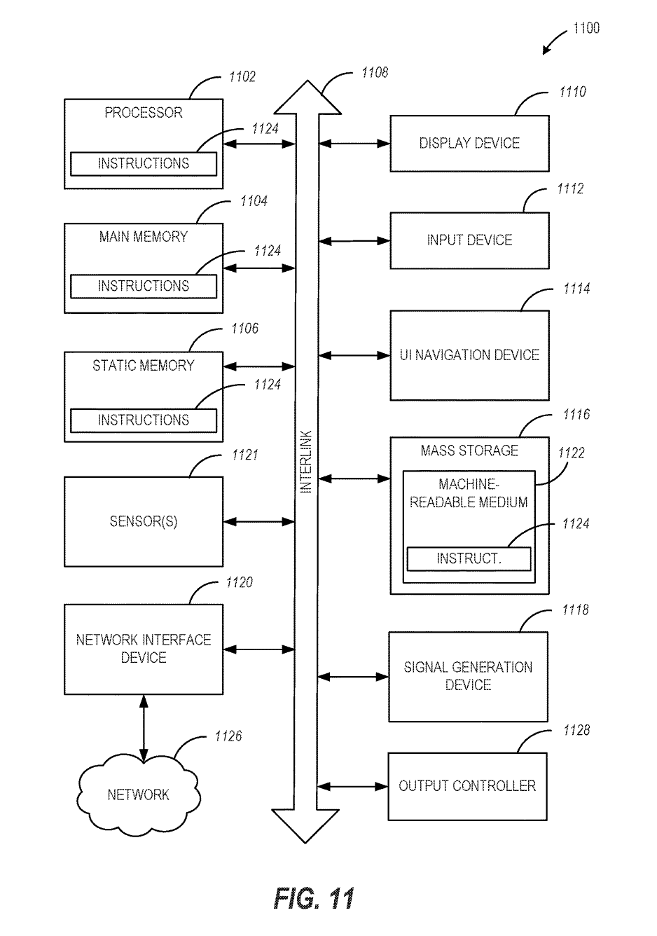

FIG. 11 illustrates a block diagram of an example machine 1100 upon which any one or more of the techniques (e.g., methodologies) discussed herein may perform. In alternative embodiments, the machine 1100 may operate as a standalone device or may be connected (e.g., networked) to other machines. Machine 1100 may execute the social networking system alone or in combination with other similar machines, including executing the campus hiring platform. In a networked deployment, the machine 1100 may operate in the capacity of a server machine, a client machine, or bath in server-client network environments. In an example, the machine 1100 may act as a peer machine in peer-to-peer (P2P) (or other distributed) network environment. The machine 1100 may be a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. an example, the whole or part of one or more computer systems (e.g., a standalone, client or server computer system) or one or more hardware processors may be configured by firmware or software—e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 1100 may include a hardware processor 1102 (e.g., a central processing unit (CPU), a graphics processing unit (GPU), a hardware processor core, or any combination thereof), a main memory 1104 and a static memory 1106, some or all of which may communicate with each other via an interlink (e.g., bus) 1108. The machine 1100 may further include a display unit 1110, an alphanumeric input device 1112 (e.g., a keyboard), and a user interface (UI) navigation device 1114 (e.g., a mouse). In an example, the display unit 1110, input device 1112 and UI navigation device 1114 may be a touch screen display. The machine 1100 may additionally include a storage device (e.g., drive unit) 1116, a signal generation device 1118 (e.g., a speaker), a network interface device 1120, and one or more sensors 1121, such as a global positioning system (GPS) sensor, compass, accelerometer, or other sensor. The machine 1100 may include an output controller 1128, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1116 may include a machine readable medium 1122 on which is stored one or more sets of data structures or instructions 1124 (e.g., software) embodying or utilized by any one or more of the techniques or functions described herein. The instructions 1124 may also reside, completely or at least partially, within the main memory 1104, within static memory 1106, or within the hardware processor 1102 during execution thereof by the machine 1100. In an example, one or any combination of the hardware processor 1102, the main memory 1104, the static memory 1106, or the storage device 1116 may constitute machine-readable media.

While the machine readable medium 1122 is illustrated as a single medium, the term “machine readable medium” may include a single medium or multiple media (e.g., a centralized or distributed database and/or associated caches and servers) configured to store the one or more instructions 1124.

The term “machine readable medium” may include any medium that is capable of storing, encoding, or carrying instructions for execution by the machine 1100 and that cause the machine 1100 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine-readable media may include non-transitory machine-readable media. In some examples, machine-readable media may include machine-readable media that is not a transitory propagating signal.

The instructions 1124 may further be transmitted or received over a communications network 1126 using a transmission medium via the network interface device 1120. The Machine 1100 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., institute of Electrical and Electronics Engineers (IEEE) 802.11 family of standards known as Wi-Fi®, IEEE 802.16 family of standards known as WiMax®). IEEE 802.15.4 family of standards, a Long Term Evolution (LTE) family of standards, a Universal Mobile Telecommunications System (UMTS) family of standards, peer-to-peer (P2P) networks, among others. In an example, the network interface device 1120 may include one or more physical jacks (e.g., Ethernet, coaxial, or phone jacks) or one or more antennas to connect to the communications network 1126. In an example, the network interface device 1120 may include a plurality of antennas to wirelessly communicate using at least one of single-input multiple-output (SIMO), multiple-input multiple-output (MIMO), or multiple-input single-output (MISO) techniques. In some examples, the network interface device 1120 may wirelessly communicate using Multiple User MIMO techniques.

To better illustrate the method and apparatuses disclosed herein, a non-limiting list of embodiments is provided here:

Example 1 is a method for providing a plurality of graphical user interfaces, the method comprising: receiving, via a first graphical user interface, a job posting from a recruiter; receiving, via a second graphical user interface, a first indication approving the job posting from a placement officer; receiving, via a third graphical user interface, an indicated interest from a plurality of students in the job posting; receiving, via the second graphical user interface a second indication approving of at least one student from the plurality of students interested in the job posting from the placement officer; sending information corresponding to the at least one student to the recruiter; receiving, via the first graphical user interface, a selection of the at least one student for an interview from the recruiter; notifying the at least one student of the interview; receiving, via the first graphical user interface, a third indication including an offer of a job corresponding to the job posting to the at least one student from the recruiter; and notifying the at least one student of the offer.

In Example 2, the subject matter of Example 1 optionally includes wherein notifying the at least one student of the interview is in response to receiving a schedule for the interview from a student coordinator via a fourth graphical user interface.

In Example 3, the subject matter of any one or more of Examples 1-2 optionally include wherein notifying the at least one student of the offer includes notifying the at least one student of the interview via the third graphical user interface.

In Example 4, the subject matter of any one or more of Examples 1-3 optionally include receiving, via the second graphical user interface, an initial registration of a school including registering the plurality of students from the placement officer.

In Example 5, the subject matter of any one or more of Examples 1-4 optionally include sending an invitation to the recruiter to register a plurality of jobs.

In Example 6, the subject matter of Example 5 optionally includes receiving a fourth indication from the recruiter accepting the invitation, and in response initializing the first graphical user interface.

In Example 7, the subject matter of any one or more of Examples 1-6 optionally include receiving a completed assessment from the at least one student and wherein the information corresponding to the at least one student includes the completed assessment.

In Example 8, the subject matter of any one or more of Examples 1-7 optionally include receiving, via the third graphical user interface, an acceptance of the offer from the at least one student.

In Example 9, the subject matter of any one or more of Examples 1-8 optionally include wherein notifying the at least one student of the offer is in response to receiving, via the second graphical user interface, a fifth indication from the placement officer. approving the offer.

In Example 10, the subject matter of any one or more of Examples 1-9 optionally include wherein notifying the at least one student of the interview includes notifying the at least one student of the interview via the third graphical user interface.

Example 11 is a machine readable medium including instructions for receiving information, which when executed by a machine, cause the machine to: receive, via a first graphical user interface, a job posting from a recruiter; receive, via a second graphical user interface, a first indication approving the job posting from a placement officer; receive, via a third graphical user interface, an indicated interest from a plurality of students in the job posting; receive, via the second graphical user interface a second indication approving of at least one student from the plurality of students interested in the job posting from the placement officer; send information corresponding to the at least one student to the recruiter; receive, via the first graphical user interface, a selection of the at least one student for an interview from the recruiter; notify the at least one student of the interview; receive, via the first graphical user interface, a third indication including an offer of a job corresponding to the job posting to the at least one student from the recruiter; and notify the at least one student of the offer.

In Example 12, the subject matter of Example 11 optionally includes wherein notifying the at least one student of the interview is in response to receiving a schedule for the interview from a student coordinator via a fourth graphical user interface.

In Example 13, the subject matter of any one or more of Examples 11-12 optionally include wherein notifying the at least one student of the offer includes notifying the at least one student of the interview via the third graphical user interface.

In Example 14, the subject matter of any one or more of Examples 11-13 optionally include receiving, via the second graphical user interface, an initial registration of a school including registering the plurality of students from the placement officer.

In Example 15, the subject matter of any one or more of Examples 11-14 optionally include sending an invitation to the recruiter to register a plurality of jobs.

In Example 16, the subject matter of Example 15 optionally includes receiving a fourth indication from the recruiter accepting the invitation, and in response initializing the first graphical user interface.

In Example 17, the subject matter of any one or more of Examples 11-16 optionally include receiving a completed assessment from the at least one student and wherein the information corresponding to the at least one student includes the completed assessment.

In Example 18, the subject matter of any one or more of Examples 11-17 optionally include receiving, via the third graphical user interface, an acceptance of the offer from the at least one student.

In Example 19, the subject matter of any one or more of Examples 11-18 optionally include wherein notifying the at least one student of the offer is in response to receiving, via the second graphical user interface, a fifth indication from the placement officer approving the offer.

In Example 20, the subject matter of any one or more of Examples 11-19 optionally include wherein notifying the at least one student of the interview includes notifying the at least one student of the interview via the third graphical user interface.

Each of the non-limiting examples above may stand on its own, or may be combined in various permutations or combinations with one or more of the other examples. Method examples described herein may be machine or computer-implemented at least in part. Some examples may include a computer-readable medium or machine-readable medium encoded with instructions operable to configure an electronic device to perform methods as described in the above examples. An implementation of such methods may include software code, such as microcode, assembly language code, a higher-level language code, or other types of software code. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and other forms of media.

What is claimed is:

1. A method for providing a plurality of graphical user interfaces, the method comprising:
receiving, via a first graphical user interface, a job posting from a recruiter;
receiving, via a second graphical user interface, a first indication approving the job posting from a placement officer;
receiving, via a third graphical user interface, an indicated interest from a plurality of students in the job posting;
receiving, via the second graphical user interface a second indication approving of at least one student from the plurality of students interested in the job posting from the placement officer;
sending information corresponding to the at least one student to the recruiter;
receiving, via the first graphical user interface, a selection of the at least one student for an interview from the recruiter;
notifying the at least one student of the interview;
receiving, via the first graphical user interface, a third indication including an offer of a job corresponding to the job posting to the at least one student from the recruiter; and
notifying the at least one student of the offer.

2. The method of claim 1, wherein notifying the at least one student of the interview is in response to receiving a schedule for the interview from a student coordinator via a fourth graphical user interface.

3. The method of claim 1, wherein notifying the at least one student of the offer includes notifying the at least one student of the interview via the third graphical user interface.

4. The method of claim 1, further comprising receiving, via the second graphical user interface, an initial registration of a school including registering the plurality of students from the placement officer.

5. The method of claim 1, further comprising sending an invitation to the recruiter to register a plurality of jobs.

6. The method of claim 5, further comprising receiving a fourth indication from the recruiter accepting the invitation, and in response initializing the first graphical user interface.

7. The method of claim 1, further comprising receiving a completed assessment from the at least one student and wherein the information corresponding to the at least one student includes the completed assessment.

8. The method of claim 1, further comprising receiving, via the third graphical user interface, an acceptance of the offer from the at least one student.

9. The method of claim 1, wherein notifying the at least one student of the offer is in response to receiving, via the second graphical user interface, a fifth indication from the placement officer approving the offer.

10. The method of claim 1, wherein notifying the at least one student of the interview includes notifying the at least one student of the interview via the third graphical user interface.

11. A machine readable medium including instructions for receiving information, which when executed by a machine, cause the machine to:
receive, via a first graphical user interface, a job posting from a recruiter;
receive, via a second graphical user interface, a first indication approving the job posting from a placement officer;
receive, via a third graphical user interface, an indicated interest from a plurality of students in the job posting;
receive, via the second graphical user interface a second indication approving of at least one student from the plurality of students interested in the job posting from the placement officer;
send information corresponding to the at least one student to the recruiter;
receive, via the first graphical user interface, a selection of the at least one student for an interview from the recruiter;
notify the at least one student of the interview;
receive, via the first graphical user interface, a third indication including an offer of a job corresponding to the job posting to the at least one student from the recruiter; and
notify the at least one student of the offer.

12. The machine readable medium of claim 11, wherein notifying the at least one student of the interview is in response to receiving a schedule for the interview from a student coordinator via a fourth graphical user interface.

13. The machine readable medium of claim 11, wherein notifying the at least one student of the offer includes notifying the at least one student of the interview via the third graphical user interface.

14. The machine readable medium of claim 11, further comprising receiving, via the second graphical user interface, an initial registration of a school including registering the plurality of students from the placement officer.

15. The machine-readable medium of claim 11, further comprising sending an invitation to the recruiter to register a plurality of jobs.

16. The machine-readable medium of claim 15, further comprising receiving a fourth indication from the recruiter accepting the invitation, and in response initializing the first graphical user interface.

17. The machine-readable medium of claim 11, further comprising receiving a completed assessment from the at least one student and wherein the information corresponding to the at least one student includes the completed assessment.

18. The machine readable medium of claim 11, further comprising receiving, via the third graphical user interface, an acceptance of the offer from the at least one student.

19. The machine readable medium of claim 11, wherein notifying the at least one student of the offer is in response to receiving, via the second graphical user interface, a fifth indication from the placement officer approving the offer.

20. The machine-readable medium of claim 11, wherein notifying the at least one student of the interview includes notifying the at least one student of the interview via the third graphical user interface.
